(19) United States
(12) Patent Application Publication
(10) Pub. No.: US 2013/0213872 A1
(43) Pub. Date: Aug. 22, 2013

(54) Treatment Devices and Methods

(71) Applicant: Patricia Phelan, Orange, CA (US)

(72) Inventor: Patricia Phelan, Orange, CA (US)

(21) Appl. No.: 13/855,573

(22) Filed: Apr. 2, 2013

Related U.S. Application Data
(63) Continuation of application No. PCT/US11/54770, filed on Oct. 4, 2011.
(60) Provisional application No. 61/389,520, filed on Oct. 4, 2010.

(51) Int. Cl. C02F 1/42

(52) U.S. Cl. CPC C02F 1/42
USPC 210/198.1; 210/484; 210/291; 210/500.1; 210/508; 210/493.1

(57) ABSTRACT

A treatment device for treating a potable liquid when submerged into the potable liquid, the treatment device including a porous enclosure enclosing an interior and filter media disposed in the interior of the porous enclosure and configured to adsorb impurities from the potable liquid entering the porous enclosure to yield a purified liquid that exits the porous enclosure, the filter media including activated carbon. In some examples, the treatment device is unaffixedly disposed in the potable liquid and/or is disposable. In some examples, the treatment device includes one or more pockets in the interior of the enclosure. Additionally or alternatively, the treatment device may include a strip incorporating filter media.

### CROSS REFERENCE TO RELATED APPLICATIONS

This application claims the benefit of and incorporates by reference for all purposes the following applications: 1) U.S. Provisional Application No. 61/389,520, filed Oct. 4, 2010; and 2) Patent Cooperation Treaty Application No. PCT/US11/54770, filed on Oct. 4, 2011.

### TECHNICAL FIELD

The present disclosure relates generally to treatment devices for treating potable liquids. In particular treatment devices embodying treatment packets and treating strips are described as well as method of using treatment devices to treat potable liquids.

### BACKGROUND

Commonly, individuals obtain purified water by purchasing purified water contained in single use plastic bottles. Although this often provides users with an easily portable source of purified water, producing, distributing, and disposing of plastic bottles results in environmental harm. Additionally, regularly purchasing purified water in single use plastic bottles results in great expense to the purchaser. Purified water contained in single-use plastic bottles may additionally have detrimental health consequences, as plastic bottles may slowly off-gas into the contained water at a rate proportional to temperature. This may result in the water containing bisphenol-A, a harmful substance. As a result of these shortcomings, there exists a need for a less expensive, healthier, and more environmentally friendly source of purified water.

Tap water, while cheaper than the water contained in single use plastic bottles, often includes potentially harmful impurities, such as chlorine. Although not the only potentially harmful impurity often contained within tap water, chlorine is of particular note due to the fact that it may create halogenated organic compounds, which are potential carcinogens, in the water. As a result, there exists a need to treat tap water in a way that reduces the content of potentially harmful impurities, such as chlorine, from the water.

Existing systems for treating tap water are not entirely satisfactory. Certain existing systems include bottles that implement a filter configured to treat liquids as they exit the bottle to a user's mouth, often through a cap or through a straw. These systems are not entirely satisfactory for several reasons. First, the filters require a manufacturer's specific container; they are not easily adaptable to non-proprietary containers. Second, these systems often include non-biodegradable materials, leading to unnecessary waste.

Additionally, many existing products implement non-disposable filters designed for multiple uses. Such non-disposable filters may become ineffective or contaminated through repeated use. Because it is often difficult to remember to replace such filters, users often inadvertently drink contaminated or non-purified water from these products.

These systems also have several features that may prevent contained liquid from being adequately purified. For example, they often leave carbon dust in the purified liquid and are susceptible to bacteria growth that may also contaminate the purified liquid. Additionally, they use plastic housings that may off-gas contaminants into the purified liquid.

Other existing systems involve large, multi-serving containers with a filter attached to a dispenser of the container. Examples of such products are marketed under the Brita® and Pur® brand names. These systems are often large and difficult to transport. Additionally, the treatment process is often impossible using anything but a collection of separate, interoperable, and proprietary components distinct to that particular product and/or manufacturer. These systems are also often difficult to properly clean. Additionally, because it is quite easy to forget the proper time to change the filter in these devices, they may lead to improper treatment by using a spent filter. The filters in these devices are often encased in plastic, which may lead to improper treatment for the reasons discussed above. Additionally, the filters used in these devices are often not recycled, producing unnecessary waste. As a result, there exists a need for an easily portable filtration solution that is easily adaptable to a wide array of containers, particularly those that are not specifically designed for use with a particular filtration system.

Additionally, known liquid treatment devices designed to treat tap water often involve installing additional plumbing and/or sink hardware within a user's home. These installations can lead to a great deal of cost and effort on the part of the user. Further, it is difficult to know when to change filters in known systems, and a failure to replace the filters may lead either to inadequate treatment or to additional expense on the part of the user. Additionally, conventional systems such as these are tied to the faucet.

In these and other known liquid treatment devices, the filters are intended to be used repeatedly and may be difficult to replace, This poses the risk of using a filter that is contaminated or has developed biological growths due to overuse or prolonged non-use. Thus, there exists a need for disposable treatment devices that are appropriate a single use and that may easily be removed from the liquid container. Additionally, there is a need for biodegradable treatment devices that reduce the environmental impact of their waste.

As a result, there exists a need for improved treatment devices that addresses one or more of these shortcomings. Treatment devices addressing one or more of the limitations discussed above are described below.

### SUMMARY

A treatment device for treating a potable liquid when submerged into the potable liquid, the treatment device including a porous enclosure enclosing an interior and filter media disposed in the interior of the porous enclosure and configured to adsorb impurities from the potable liquid entering the porous enclosure to yield a purified liquid that exits the porous enclosure, the filter media including activated carbon. In some examples, the treatment device is unaffixedly disposed in the potable liquid and/or is disposable. In some examples, the treatment devices include one or more pockets in the interior of the enclosure. Additionally or alternatively, treatment devices may include a strip incorporating filter media.

### BRIEF DESCRIPTION OF THE DRAWINGS

FIG. 1 is a perspective view of a first example of a treatment device embodied as a treatment packet unaffixedly disposed within a container containing a potable liquid.

FIG. 2 is a top plan view of the treatment device embodied as a treatment packet shown in FIG. 1.

FIG. 3 is a cross-sectional view of the treatment device embodied as a treatment packet shown in FIG. 1 taken about the line 3-3 illustrating two pockets enclosed by the treatment packet.

FIG. 4 is a perspective view of a second example of a treatment device embodied as a treatment packet.

FIG. 5 is a cross-sectional view of the treatment packet shown in FIG. 4 taken about the line 5-5.

FIG. 6A is a top view of the treatment packet shown in FIG. 4.

FIG. 6B is a top view of the treatment packet shown in FIG. 5A in a manipulated configuration.

FIG. 7 is a perspective view of a third example of a treatment device embodied as a treatment packet.

FIG. 8 is a cross-sectional view of the treatment packet shown in FIG. 6 taken about the line 7-7 illustrating the interior of a pocket enclosed by the treatment packet.

FIG. 9 is a flowchart depicting a method for treating a potable liquid.

FIG. 10 is a perspective view of an example of a treatment device embodied as a treating strip.

FIG. 11 is a cross-sectional view of the treatment device shown in FIG. 10 taken about the line 11-11.

FIG. 12 is a perspective view of a second example of a treatment device embodied as a treating strip.

FIG. 13 is a cross-sectional view of the treatment device shown in FIG. 12 taken about the line 13-13.

### DETAILED DESCRIPTION

The disclosed treatment devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various treatment devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

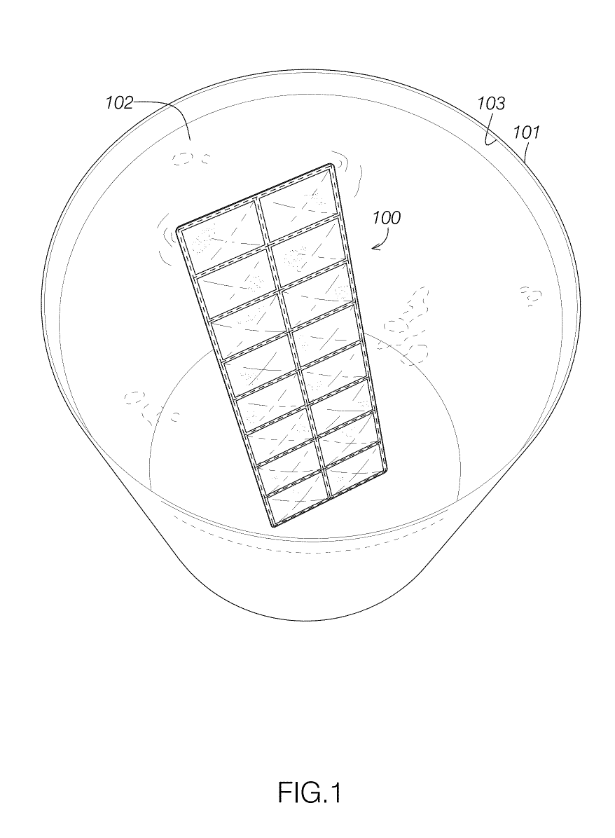

With reference to FIGS. 1-3, a first example of a treatment device embodied as a treatment packet, treatment packet 100, will now be described. Treatment packet 100 is a disposable water treatment device configured to treat a potable liquid 102 when unaffixedly within a container 101 defining an opening 103 and submerged in potable liquid 102. Treatment packet 100 includes an enclosure 110, filter media 130, and a mineral enhancer 140.

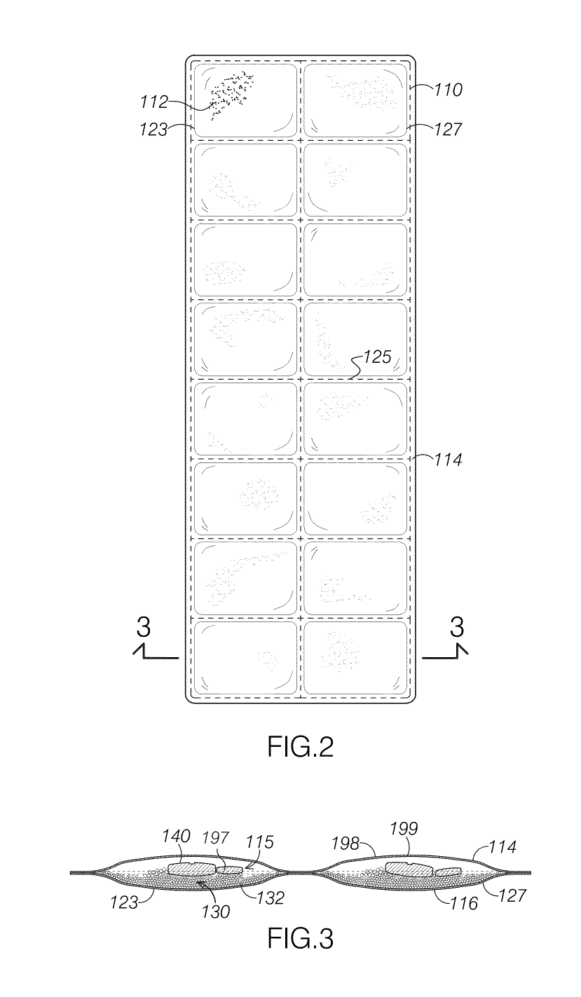

As FIGS. 1 and 2 illustrate, disposable enclosure 110 is configured to be removably disposed within potable liquid 102. As FIGS. 2 and 3 show, enclosure 110 includes pores 112 and a collection of pockets including a first pocket 123 and a second pocket 127. Enclosure 110 is configured to be selectively disposed within container 101 and is permeable by potable liquid 102. As FIG. 3 illustrates, enclosure 110 is primarily made of a porous enclosure material 199 and defines an exterior surface 198.

As FIG. 3 illustrates, enclosure 110 includes an upper body 114 stitched to a lower body 116 and encloses an interior 115 in the space between upper body 114 and lower body 116. As FIG. 2 illustrates, upper body 114 and lower body 116 are made of a porous cellulose-based paper which are natural materials that provide flexibility. Because upper body 114 and lower body 116 are made of a cellulose-based paper, enclosure 110 is biodegradable. This disclosure separately contemplates use of cellulose-based materials and paper materials for enclosure materials; this disclosure contemplates non-cellulose-based paper enclosures, and vice versa. This disclosure specifically contemplates the environmental benefit of implementing natural and/or biodegradable construction materials, such as paper. However, other examples may implement a fibrous borosilicate glass upper and lower bodies, or bodies made of other porous materials.

Enclosure 110 includes pores 112 exposed to potable liquid 102 and configured to allow potable liquid 102 to enter and exit interior 115. The size of pores 112 may control the rate at which potable liquid 102 flows in and out of interior 115. Pores 112 range in size from one to ten microns; however, pores may be any size that generally allows passage of potable liquid 102 while restricting passage of filter media. In some embodiments, a smaller pore size may be selected to maximize the time in which liquid remains contained within interior 115 and in contact with filter media to increase the contact time with the filter media, thereby improving filtration.

As FIG. 2 shows, enclosure 110 defines a collection of attachment areas 125, at which upper body 114 and lower body 116 are stitched to one another. Although stitching is specifically illustrated, other attachment means, such as machine-pressing, stapling, or adhesion may be used. Interior 115 is separated into a collection of pockets, including first pocket 123 and second pocket 127, by stitching together upper body 114 and lower body 116 at attachment areas 125. Although a certain number of pockets are shown, this disclosure specifically contemplates treatment packets with more pockets and with multiple spaced pocket layers to increase enclosure surface area and available filter media to the a liquid to be filtered.

As FIG. 3 illustrates, treatment packet 100 includes filter media 130 disposed within interior 115. Filter media 130 is composed in whole or in part of one or more filter materials selected for their ability to remove selected impurities from liquid. Specifically, filter media 130 includes a filter material comprising activated carbon granules 132 disposed in first pocket 123. As FIG. 1 illustrates, filter media 130 is disposed in each pocket.

Filter media 130 fills approximately ⅓ of an enclosure volume defined by enclosure 110. Filling first pocket 123 with granular activated carbon at this ratio allows potable liquid 102 to efficiently flow through enclosure 110 into first pocket 123 and mix with the filter media. The ideal ratio of total pocket volume to media volume should approximate two to one or three to one. Filling at these ratios additionally maximizes the media surface area available to the liquid, thus augmenting treatment. However, this ratio is not specifically required. This disclosure considers pockets substantially full of the media to increase the amount of filter media available, as well as well as substantially empty pockets to increase the flexibility of enclosure 110.

Enclosure 110 may be folded around filter media 130 as a result of implementing a granular filter media 130 and a flexible enclosure 110. By folding enclosure 110, treatment packet 100 may be easier to insert into a container with a small opening, such as a standard disposable water bottle or reusable water bottles. As previously mentioned, enclosure 110's flexibility may be increased by decreasing the amount of filter media disposed within enclosure 110's pockets.

Granulated activated carbon is chosen as a potential filter media largely because it reduces the chlorine content of a liquid to which it is exposed. Though not required, the activated carbon used is of premium quality, preferably from coconut shells. Additionally, the activated carbon may be selected to have an increased hardness.

Additionally or alternatively, filter media may include an ion-exchange resin. The ion-exchange resin may be placed in the interior of a pocket in a similar manner to the granular activated carbon. Ion exchange resins may additionally or alternatively be impregnated in enclosure material. Ion exchange resins may additionally or alternatively be attached to the interior and/or exterior surfaces of enclosures, such as exterior surface 198 and interior surface 196. Ion-exchange resins are an organic polymer substance, which often take the form of small, solid beads. However ion-exchange resins may be implemented in liquid form without any container as well. Ion-exchange resins include pores on their surface that trap and release ions that treat the liquid through an ion-exchange process. This disclosure specifically contemplates using any known or later developed type of ion-exchange resin.

Additionally or alternatively, filter media may also include high purity copper-zinc formulations, such as KDF 55 and KDF 85. Copper-zinc formulations treat liquid by an oxidation/reduction process by exchanging electrons to bond with chlorine and other metals in the water to create harmless substances. Such copper-zinc formulations may be used to remove chlorine, mercury, nickel, lead, chromium, and other dissolved metals from the purified liquid. Copper-zinc formulations may be included to control bacteria levels in the purified liquid.

Granulated activated carbon, ion-exchange resins, and high-density copper formulations are specifically discussed as filter materials due to their water treatment characteristics. This disclosure contemplates filter media including any combination of the three. This disclosure additionally contemplates filter media that include any combination of additional or alternative water treatment implements, which may include, but are not limited to carbon, ion-exchange resins, mineral nanofibers such as nanoalumina, manufactured nanofibers, polypropylene, polyester, and/or other polymer substrates. This disclosure also specifically contemplates filter media including one or more filter materials.

As FIG. 3 illustrates, treatment packet 100 additionally includes second pocket 127 spaced from first pocket 123. Second pocket 127 includes a second filter media 128 including an ion-exchange resin. This disclosure discusses first pocket 123 and second pocket 127 individually with each pocket including different single-composition filter media. However, first pocket 123 and second pocket 127 are discussed as a microcosm of treatment packet 100's plurality of pockets illustrated in FIG. 2. First pocket 123 and second pocket 127 illustrate that treatment packets may include diverse filter medias disposed in each of a treatment packet's pockets. In some embodiments, each pocket will include the same filter media; however, various other embodiments may include disparate filter media disposed in the pockets.

As FIG. 3 shows, treatment packet 100 includes mineral enhancer 140 disposed within first pocket 123. Mineral enhancer 140 defines a dissolvable tablet containing a mineral deemed to have health benefits when consumed in a liquid. Mineral enhancer 140 is disposed within enclosure 110 and is configured to dissolve into potable liquid 102 as treatment packet 100 purifies potable liquid 102. As a result, mineral enhancer 140 imbues the purified liquid with the minerals' health benefits.

The mineral enhancer may include calcium, magnesium, and/or potassium. However, mineral enhancers are not specifically confined to these minerals. Minerals contained within the mineral enhancer may be selected to be of the highest quality form. With regard to a mineral enhancer including calcium, citrate or hydroxyapatite forms should be used. The mineral enhancer may include selected minerals in any quantity and/or potency, specifically including amounts appearing naturally in untreated spring water.

Looking to FIG. 3, treatment packet 100 additionally includes a electrolyte supplement 197 disposed within first pocket 123. The electrolyte supplement may comprise a collection of one or more of sodium, potassium and/or magnesium and is configured to dissolve or partially dissolve into potable liquid 102 to imbue potable liquid 102 with electrolyte balancing characteristics.

Mineral enhancer 140 and electrolyte supplement 197 are displayed as tablets for illustrative purposes. Their particular form is not a requirement of the subject matter of this disclosure, and they may take any shape and/or may exist as discrete granules.

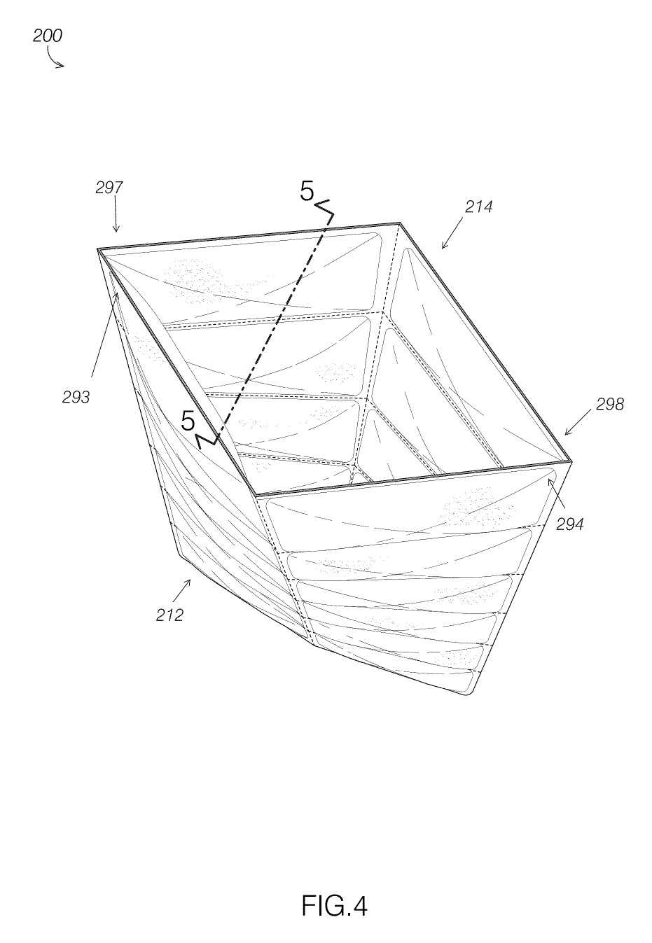

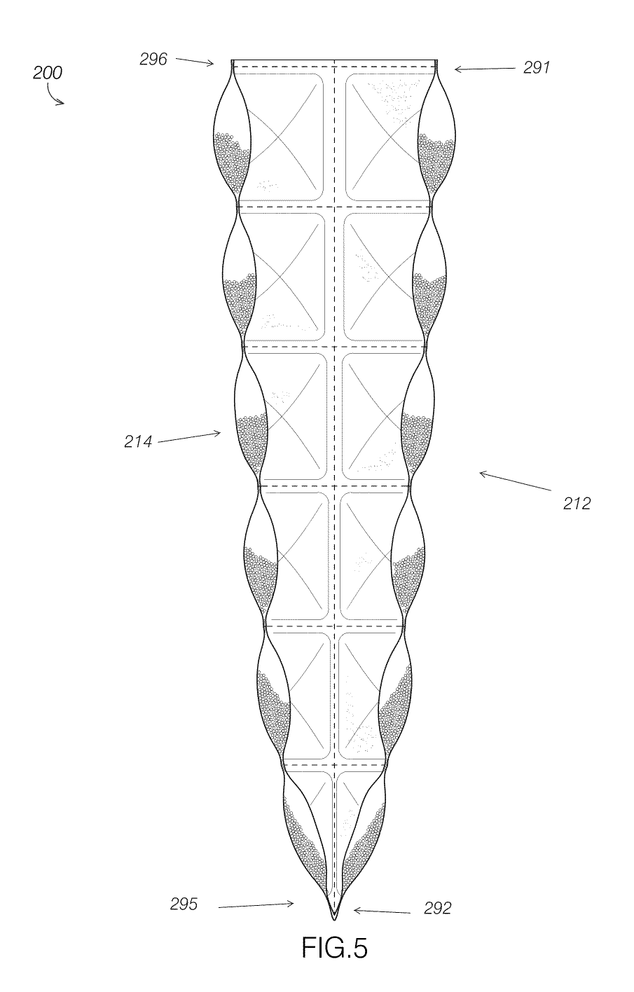

FIGS. 4-6B illustrate a second example of a treatment device embodied as a treatment packet configured to be placed in a potable liquid, treatment packet 200, which includes an first porous enclosure 212 and a second porous enclosure 214. First porous enclosure 212 extends longitudinally from a top 291 to a bottom 292 and laterally from a first side 293 to a second side 294. Second porous enclosure 214 similarly extends longitudinally from a bottom 295 to a top 296 and laterally from a first side 297 to a second side 298. Treatment packet 200 includes a series of attachment points 225 that attach first porous enclosure 212 to second porous enclosure 214. Attachment points 225 attach first side 293 to first side 297, second side 294 to second side 298, and bottom 292 to bottom 295. In this manner, treatment packet 200 defines a pocket interior 290, into which liquid may flow. This provides a greater surface area in which the liquid is in contact with treatment packet 200 and any contained filter media. First porous enclosure 212 is primarily made of a porous enclosure material and defines an exterior surface and an interior surface, similar to enclosure 110.

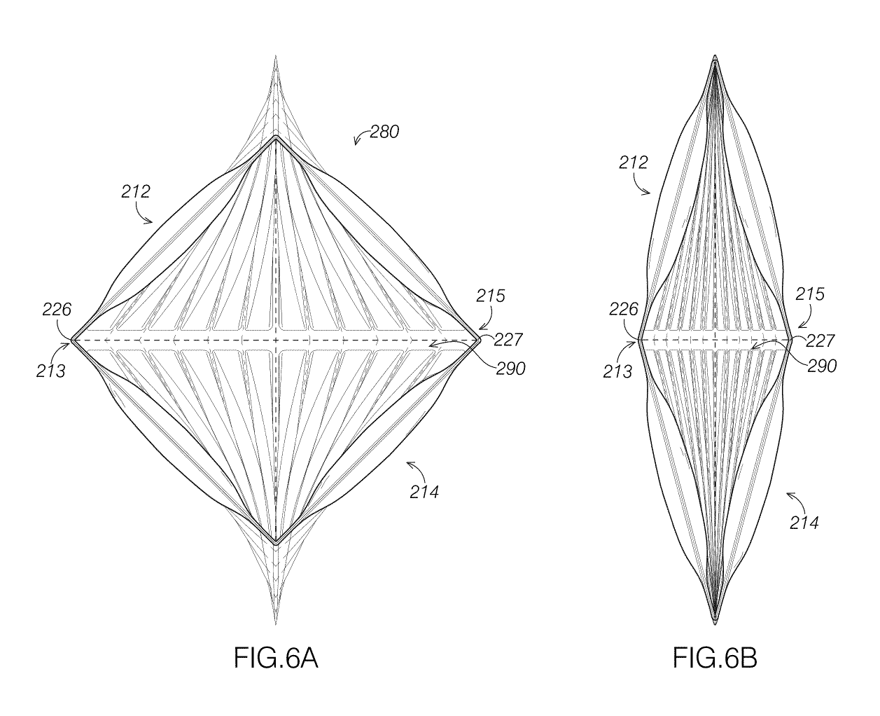

As FIG. 6A and 6B show, first porous enclosure 212 is flexible and includes a midpoint 213 may be manipulated to space first porous enclosure 212 from second porous enclosure 214. Second porous enclosure 214 is similarly flexible and similarly includes a midpoint 215, which may be manipulated in the same manner.

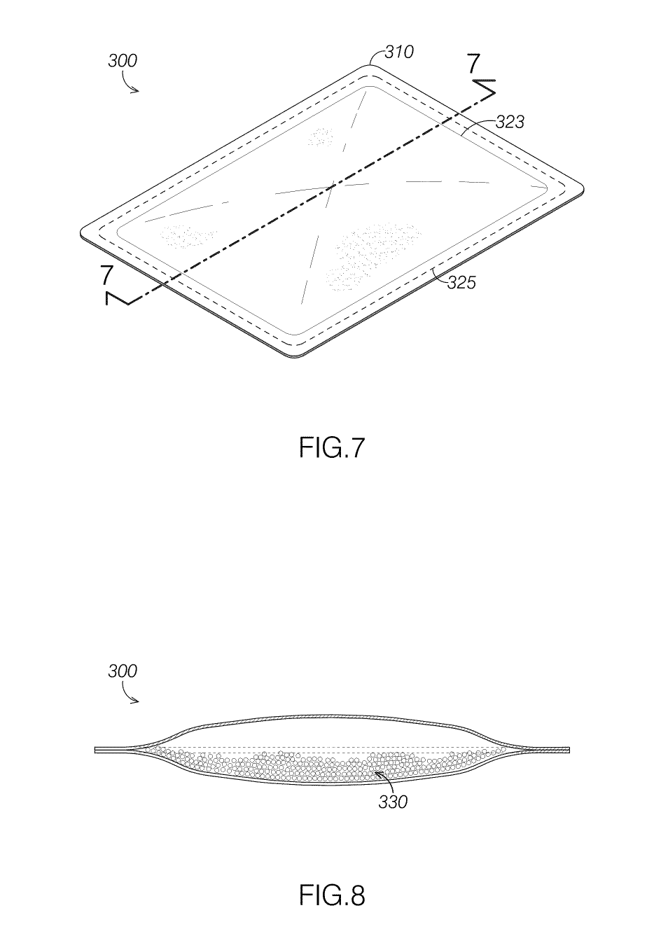

FIGS. 7 and 8 illustrate a third example of a treatment device embodied as a treatment packet, treatment packet 300. Treatment packet 300 is a disposable, single-pocket design that resembles a single-use tea bag. Treatment packet 300 implements many of the concepts discussed in this disclosure in a substantially similar manner to treatment packet 100 and treatment packet 200. Treatment packet 300 includes a disposable enclosure 310 enclosing an interior defining a pocket 323. Enclosure 310 is primarily made out of a porous enclosure material and defines an exterior surface and an interior surface, similar to enclosure 110. As FIG. 7 shows, a collection of attachment points 325 secure enclosure 310 around pocket 323. As FIG. 8 illustrates, pocket 323 includes filter media 330 defining activated carbon granules, substantially similar to first pocket 123.

In other treatment packet examples, such as those similar to treatment packet 100, treatment packet 200, or treatment packet 300, filter media may additionally or alternatively be impregnated within the enclosure material. In other examples, filter media may additionally or alternatively be attached to the exterior and/or interior surfaces of the enclosure.

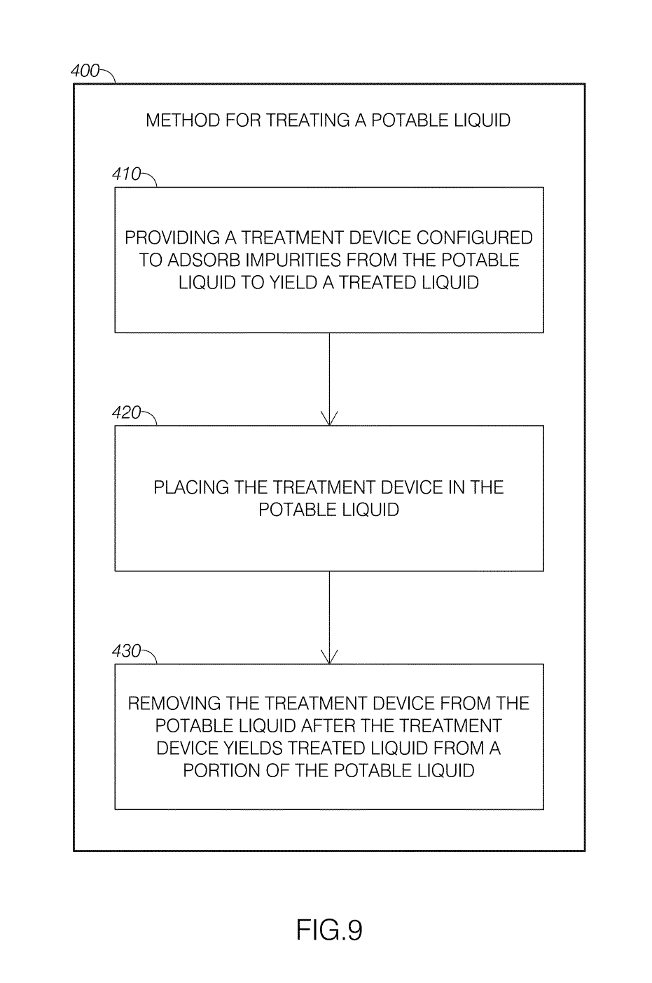

FIG. 9 illustrates an example of a method for filtering a potable liquid contained within a container, method for treating a potable liquid 400. Method for treating a potable liquid 400 includes the steps of providing a treatment device configured to adsorb impurities from the potable liquid to yield a treated liquid 410, placing the treatment device in the potable liquid 420, and removing the treatment device from the potable liquid after the treatment device yields treated liquid from a portion of the potable liquid 430.

The treatment device implemented in method for treating a potable liquid 400 may be, but is not required to be, substantially similar to treatment packet 100, treatment packet 200, treatment packet 300, or other disclosed treatment devices. In some examples, the treatment device implemented in method for treating a potable liquid 400 is disposable and is configured to be disposed after removing the treatment device from the potable liquid after the treatment device yields treated liquid from a portion of the potable liquid 430. Further, disposable treatment packets used in method for treating a potable liquid 400 may be made of natural, recyclable, biodegradable and/or compostable materials, thereby providing environmental benefits.

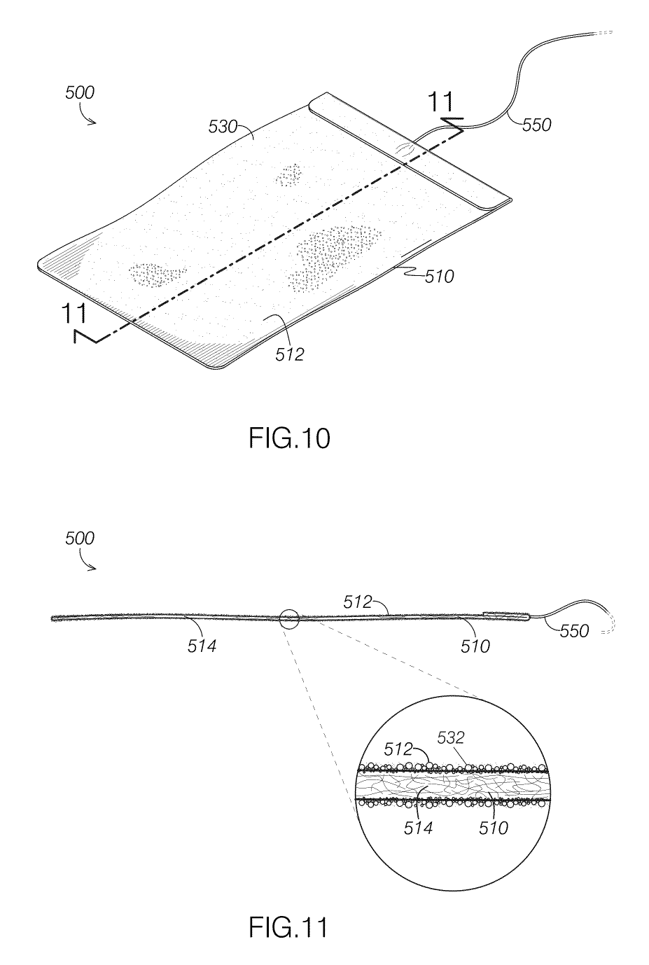

Turning attention to FIGS. 10 and 11, an example of a treatment device embodied as a treating strip, treating strip 500, will now be discussed. Treating strip 500 includes a strip 510, fitter media 530, and a line 550. Treating strip 500 is configured to be placed in a potable liquid to yield treated liquid from at least a portion of the potable liquid. Treating strip 500 yields purified liquid similar to the disclosed treatment packets. However, by incorporating filter media 530 with strip 510, treating strip 500 may produce less waste and incur less manufacturing costs.

As shown in FIG. 11, strip 510 is made of a strip material 514. Strip 510 defines a surface 512. The strip material may include, but is not limited to, wood, cellulose, biopolymers, polylactic acid, polypropylene, polyester, other polymer substrates, rayon, or borosilicate glass. The use of natural materials, such as the aforementioned cellulose, biopolymers, and polylactic acid, may be used to reduce porous sheets' environmental impact.

As FIG. 11 shows, treating strip 500 incorporates filter media 530, which includes an ion exchange resin 532. Filter media 530 is attached to strip 510 by impressing or applying filter media 530 to surface 512. Strips used for attachment of a filter media in this manner may be, but are not required to be, porous. Additionally or alternatively, strips used for attachment of a filter media in this manner may be, but are not required to be, fibrous.

However, in other similar examples, filter media may be attached by affixing the filter media to the surfaces. In some such examples, the filter media may be bound to the surface by an adhesive. In such examples, the filter media may include solid filter media, including, but not limited to, all solid forms of filter media described above.

As FIG. 10 shows, line 550 defines a string extending from treating strip 500. Line 550 may be gripped by a user to remove treating strip 500 from a container containing a potable liquid. Line 550 may additionally or alternatively extend outside of the container during use, providing a user the opportunity to remove treating strip 500 without touching the potable liquid. Because touching the potable liquid could introduce additional impurities, line 550 prevents users from inadvertently adding impurities to the potable liquid.

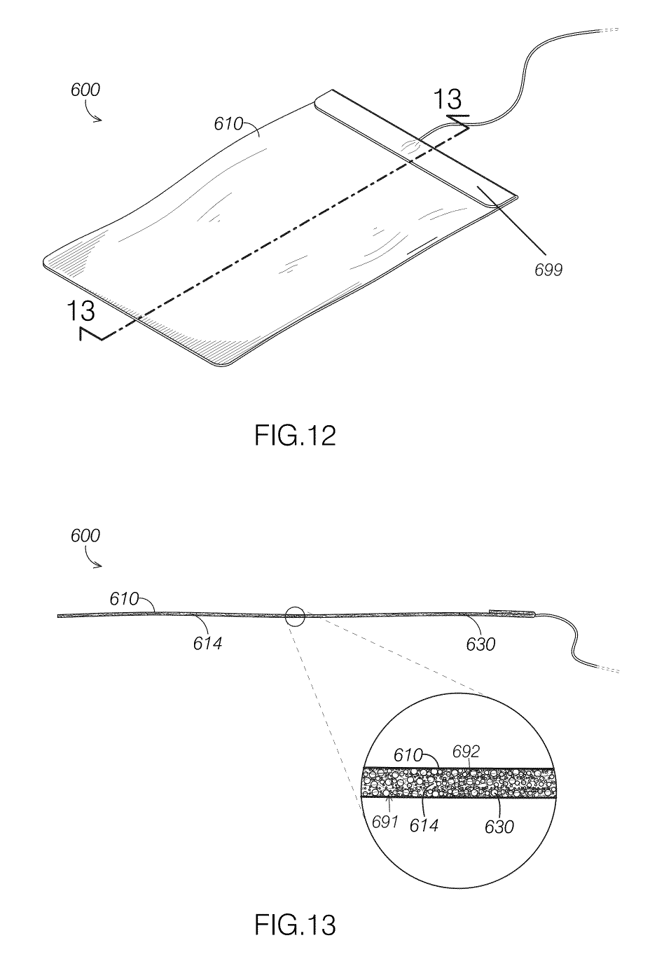

Turning attention to FIGS. 12 and 13, a second example of a treatment device embodied as a treating strip, treating strip 600, will now be discussed. Treating strip 600 includes a porous strip 610 and filter media 630.

Treating strip 600 is similar in design and composition to strip 510, similarly comprising a porous strip material 614 defining a pore network 691 defining pores and a skeletal network 692 surrounding the pores. Likewise, filter media 630 is incorporated with porous strip 610. Filter media 630 similarly defines an ion exchange resin.

As FIG. 13 illustrates, however, a difference is seen in the manner in which filter media 630 is incorporated with porous strip 610. As FIG. 13 illustrates, filter media 630 is incorporated by impregnating filter media 630 in porous strip material 614. Filter media 630 is retained in position within pore network 691 by skeletal network 692.

This disclosure contemplates impregnating porous materials with filter media to define a treatment device independent of the filter media or the method of impregnating. Indeed, solid filter media may additionally or alternatively be impregnated within porous materials by retaining granules of solid filter media within the fibers of a fibrous porous strip material.

Porous strips impregnated with a filter media similar to treating strip 600 may be, but are not required to be, fibrous. As an example, treating strip 600 illustrates a fibrous example, wherein skeletal network 692 includes the fibrous strip material's fibers and pore network 691 includes the voids between the fibers. However, treating strips may take any porous configuration. Treating strips are not required to be fibrous, nor are they required to follow treating strip 600's specific pore and skeletal network design.

In some examples of strips and/or enclosures, the strip or enclosure may include one or more pleats along its length. For example, treating strip 600 defines a pleat 699. Pleats are not required to be sewn or take the form of pleat 699. For example, pleat arrangements on the strip may include, but are not limited to, accordion pleats, box pleats, knife pleats, organ pleats, or other generally understood pleat types. By including pleats, the treatment strip exposes a greater amount of surface area to the liquid, which may result in superior treatment.

For the purposes of this discussion, ‘porous’ is defined as having any porosity, including structures that include only a single pore. As a result, ‘porous’ may specifically include structures incapable of communicating water through the full thickness of the structure. Additionally or alternatively, porous structures, including porous strips and porous enclosures, may be constructed by adding pores to non-porous materials. Additionally, porous structures may include both porous and non-porous portions.

Examples of enclosure and strip materials may include, but are not limited to, cellulose, biopolymers, polylactic acid, polypropylene, polyester or other polymer substrates, rayon, or borosilicate glass.

In some treatment device examples implementing porous materials, the porous material may include and/or define a fibrous material. Additionally or alternatively, non-porous fibrous materials, such as tarpaulin, may be used.

In some examples, plastic and/or wooden stirring sticks may function as strips. These examples may be particularly suited in examples including a strip with filter media attached to the surface, but may serve as strips for any treatment device disclosed herein.

Strips as disclosed in this example are not limited to substantially elongated shapes, nor are the limited to distinct bodies. Strips according to this disclosure may define any shape, including any circular, polygonal, or non-polygonal, non-circular shape. Additionally, strips may define a part or a portion of a larger structure, such as an enclosure or a filter.

### INDUSTRIAL APPLICABILITY

The inventions described in this application may be manufactured by a wide variety of industrial methods. Further, the treatment device inventions described herein may be used with any number of consumer containers, glasses, or bottles to treat water or other liquids. The disclosed treatment devices enable a user to treat potable liquids on demand without a large, unwieldy apparatus.

The inventions described above may be alternatively described according to the following non-limiting embodiments:

In an embodiment for a treatment device for treating a potable liquid when unaffixedly disposed within a container containing the potable liquid, the treatment device may include, but is not limited to, a porous enclosure enclosing an interior and filter media disposed in the interior of the porous enclosure. The filter media may be configured to adsorb impurities from the potable liquid entering the porous enclosure to yield a purified liquid that exits the porous enclosure. The filter media may include, hut is not limited to, activated carbon. In examples where the filter media includes activated carbon, the activated carbon may be granular.

In some examples, the porous enclosure may define a plurality of pockets. The porous enclosure may include pores with maximum dimensions that are smaller than particles of the filter media to restrict the filter media particles from passing through the pores in some examples. In some examples, the porous enclosure may be biodegradable. In some further examples, the porous enclosure may be made of a flexible material. The interior of the porous enclosure may define a plurality of pockets.

The filter media may additionally or alternatively include an ion-exchange resin in some examples. In some further examples, the filter media may additionally or alternatively include copper-zinc formulations. Some further examples may additionally comprise an electrolyte balancing supplement disposed in the interior of the porous enclosure.

Some examples may additionally comprise a mineral enhancer disposed in the porous enclosure. In examples including a mineral enhancer, the mineral enhancer may include a mineral selected from a group consisting of calcium, magnesium, and potassium. Some examples may include a flavor supplement disposed in the interior of the porous enclosure.

In some examples, the porous enclosure may incorporate filter media.

In an embodiment for a single-use treatment device for treating a potable liquid when submerged into the potable liquid, the treatment device may include a disposable porous enclosure enclosing an interior, a pocket defined by the porous enclosure, the pocket enclosing a pocket interior, and filter media disposed in the pocket interior, wherein the filter medium contacts the liquid entering the pocket interior and purifies the potable liquid, which exits the pocket interior as a purified liquid.

In some examples, the pocket defines a first pocket and the filter media defines a first filter media, and the treatment device additionally comprises a second pocket defined by the porous enclosure, the second pocket enclosing a second pocket interior, and the second pocket is spaced from the first pocket and includes a second filter media comprising a different chemical composition than the first.

In some further examples, the porous enclosure defines a first porous enclosure and the pocket defines a first pocket, wherein the first porous enclosure extends from a top to a bottom and extends from a first side to a second side and the treatment device further comprises a second porous enclosure defining a second pocket, the second porous enclosure attached to the bottom of the first porous enclosure, the first side of the first porous enclosure, and the second side of the first porous enclosure. In examples with a second porous enclosure, a midpoint of the first porous enclosure may be configured to be selectively spaced from the second porous enclosure.

Additionally or alternatively, an embodiment of a method for treating a potable liquid in a container may comprise providing a treatment device configured to adsorb impurities from the potable liquid to yield a purified liquid, placing the treatment device in the potable liquid, and removing the treatment device from the potable liquid after the treatment device yields treated liquid from at least a portion of the potable liquid. In some examples, such a method may implement previously disclosed treatment devices.

Additionally or alternatively, an embodiment of a treatment device for treating a potable liquid when submerged into the potable liquid, the treatment device may comprise a strip incorporating filter media. In some examples, the strip may define a surface and the filter media may be attached to the surface. In some examples, the strip may be porous and/or fibrous. In some examples, the strip material may define a pore network that defines pores and a skeletal network surrounding the pores, and the skeletal network may retain the filter media in the pores. Additionally, or alternatively, the strip may be impregnated with the filter media. In some examples, the filter media may include an ion exchange resin.

The terms treatment device, treatment packet, and treatment sheet are used to describe the inventions and specific embodiments disclosed herein. The terms treat, purify, and related terms should not be read to limit the functions and capabilities of the disclosed inventions to purification and/or treatment. Indeed, the disclosed inventions may treat liquid and perform other functions as well. For example, some embodiments of the invention introduce desired substances into a liquid in addition to treating the liquid.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A single-use treatment device for treating a potable liquid when submerged into the potable liquid, the treatment device comprising:
a disposable porous enclosure;
a pocket defined by the porous enclosure; and
filter media disposed in the pocket;
wherein the filter media is configured to purify the potable liquid when the potable liquid enters the pocket and contacts the filter media.

2. The Error! Reference source not found. of claim 1, wherein:
the pocket defines a first pocket; and
the filter media defines a first filter media;
further comprising a second pocket defined by the porous enclosure;
wherein the second pocket is spaced from the first pocket and includes a second filter media comprising a different chemical composition than the first filter media.

3. The Error! Reference source not found. of claim 1, wherein:
the porous enclosure defines a first porous enclosure;
the pocket defines a first pocket; and
the first porous enclosure extends from a top to a bottom and extends from a first side to a second side;
further comprising a second porous enclosure defining a second pocket, the second porous enclosure attached to the bottom, the first side, and the second side of the first porous enclosure.

4. The Error! Reference source not found. of claim 3, wherein a midpoint of the porous enclosure is configured to be selectively spaced from the second porous enclosure.

5. The treatment device of claim 1, wherein the porous enclosure is not affixed to a container containing the potable liquid when the porous enclosure is disposed in the potable liquid.

6. The treatment device of claim 1, wherein the filter media includes an ion-exchange resin.

7. The treatment device of claim 1, further comprising a mineral enhancer disposed in the porous enclosure, the mineral enhancer including calcium, magnesium, or potassium.

8. The treatment device of claim 1, wherein:
the filter media defines particles; and
the porous enclosure defines pores with maximum dimensions that are smaller than the particles of the filter media to restrict the particles of the filter media from passing through the pores.

9. A treatment device for treating a potable liquid when submerged into the potable liquid, the treatment device comprising a strip of material incorporating filter media.

10. The treatment device of claim 9, wherein the strip of material defines a surface and the filter media is attached to the surface.

11. The treatment device of claim 10, wherein the strip of material is porous.

12. The treatment device of claim 10, wherein the strip of material is fibrous.

13. The treatment device of claim 9, wherein the strip of material is impregnated with the filter media.

14. The treatment device of claim 13, wherein the strip of material is porous.

15. The treatment device of claim 14, wherein the porous material is fibrous.

16. The treatment device of claim 13, wherein:
the strip material defines a network of pores;
the strip material defines a skeletal network surrounding pores within the network of pores; and
the skeletal network is configured to retain the filter media in the pores within the network of pores.

17. The treatment device of claim 9, wherein the filter media includes an ion exchange resin.

18. The treatment device of claim 9, further comprising a mineral enhancer incorporated in the strip of material, the mineral enhancer including calcium, magnesium, or potassium.

19. The treatment device of claim 9, wherein the strip of material is not affixed to a container containing the potable liquid when the porous enclosure is disposed in the potable liquid.

20. The treatment device of claim 9, wherein the strip defines a pleat.
